(19) United States
(12) Patent Application Publication
(10) Pub. No.: US 2023/0248152 A1
(43) Pub. Date: Aug. 10, 2023

(54) Laptop computer holder attached to armrests

(71) Applicant: Ting Li, Shenzhen (CN)

(72) Inventor: Ting Li, Shenzhen (CN)

(21) Appl. No.: 18/134,045

(22) Filed: Apr. 13, 2023

(30) Foreign Application Priority Data
Mar. 23, 2023 (CN) 202320576479.8

(51) Int. Cl. A47C 7/68; A47C 7/62; G06F 3/039

(52) U.S. Cl. CPC A47C 7/705; A47C 7/622; G06F 3/0395

(57) ABSTRACT

A laptop computer holder includes a table; a first connector and a second connector arranged at a lower end of the table in which the first connector is sleeved on one armrest of a chair, the second connector is sleeved on the other armrest of the chair, and the first connector is fastened with a bottom end of the table; a bottom of the table provided with a sliding groove extending from one armrest of the chair to the other armrest thereof; and a sliding member arranged in the sliding groove and fastened with the second connector. The first connector and the second connector each include a sleeve hole. The sleeve holes are sleeved on the armrests of the chair respectively.

### FIELD OF THE INVENTION

The invention relates to holders and more particularly to a holder for a laptop computer, the holder being adapted to attach to two armrests of a chair.

### BACKGROUND OF THE INVENTION

At present, a laptop computer holder matched with a chair is detachably fastened on an air pressure rod of the chair by using a supporting rod or fixed at a bottom of a seat of the chair. A disadvantage is that height adjustment or fixation of the laptop computer holder is realized through a complex structural part.

Thus, the need for improvement still exists.

### SUMMARY OF THE INVENTION

An objective of the invention is to provide a laptop computer holder matched with an armrest of a chair, to resolve the problem in the background.

To solve the above technical problem, the invention adopts the following technical solution:

A laptop computer holder matched with an armrest of a chair includes a table for supporting a laptop computer. A first connector and a second connector are arranged at a lower end of the table. The first connector is sleeved on any armrest of the chair, and the second connector is sleeved on the other armrest of the chair.

The first connector is fastened with a bottom end of the table.

A bottom of the table is provided with a sliding groove extending from one armrest of the chair to the other armrest. A sliding member is arranged in the sliding groove, and the sliding member is fastened with the second connector.

The first connector and the second connector each include a sleeve hole that is formed by bending downward and wrapping, and the sleeve hole is sleeved on the armrest of the chair.

Further, a laptop computer bracket is arranged on the table. The laptop computer bracket includes a supporting surface. The supporting surface is close to a left hand side of a human according to a posture of the human sitting on the chair as a reference.

The supporting surface is rotationally installed at a position that is of the table and that is close to the human sitting on the chair.

A rotary height adjustment plate is arranged in a middle part of a back surface of the supporting surface, and the other end of the height adjustment plate is inserted into a limiting hole of the table.

Further, there are a plurality of limiting holes, and the plurality of limiting holes are distributed in a longitudinal direction of the table.

Further, a first heat dissipation hole penetrating the supporting surface is formed on the supporting surface.

Further, a supporting surface storage groove is formed on the table, the supporting surface is rotationally installed in the supporting surface storage groove, and the limiting hole is formed in the storage groove.

A second heat dissipation hole penetrating the table is formed in the supporting surface storage groove.

Further, a baffle storage groove is arranged on a front supporting surface close to the table.

A baffle is rotationally installed in the baffle storage groove. When the laptop computer is placed on the supporting surface, a free end of the baffle extends out of the baffle storage groove to support an edge of a lower end of the laptop computer.

Further, a mouse pad is embedded in a surface of the table, and the mouse pad is close to a right hand side of a human according to a posture of the human sitting on the chair as a reference.

Further, a round hole for placing a coffee cup is formed on the table, and the round hole is close to a right hand side of a human according to a posture of the human sitting on the chair as a reference.

Further, an elongated hole for placing a mobile phone is formed on the table.

The invention has the following advantages and benefits in comparison with the conventional art:

The laptop computer holder provided in the invention has a simple structure, so that it can be installed on the chair in a sleeving manner and used for placing the laptop computer.

In addition, a spacing between the first connector and the second connector is adjustable, so that the laptop computer holder of the present disco lure can be applied to a chair with a difference spacing between armrests.

In addition, a distance between the laptop computer holder and the human sitting on the chair can be adjusted by moving positions of the sleeve hole and the armrest of the chair, so that comfort of a user is improved.

For a chair of which a height of an armrest can be adjusted, a height between the laptop computer holder and the ground can be adjusted based on this feature, which is equivalent to reducing a height adjustment mechanism, that is, a structure of the holder is simplified.

The above and other objects, features and advantages of the invention will become apparent from the following detailed description taken with the accompanying drawings

### BRIEF DESCRIPTION OF THE DRAWINGS

FIG. 1 is a perspective view of a laptop computer holder according to the invention;

FIG. 2 is another perspective view of the laptop computer holder;

FIG. 3 is a perspective view taken from a bottom of the laptop computer holder;

FIG. 4 is a partial exploded view of FIG. 3;

FIG. 5 is still another perspective view of FIG. 1 showing the supporting surface pivoted to an inclined position;

FIG. 6 is another perspective view of FIG. 5; and

FIG. 7 is a perspective view of the laptop computer holder attached to two armrests of a chair.

### DETAILED DESCRIPTION OF THE INVENTION

The technical solutions in embodiments of the invention will be described below clearly and completely with reference to the accompanying drawings in embodiments of the invention. Apparently, the described embodiments are only a part, rather than all of embodiments of the invention. All other embodiments obtained by those of ordinary skill in the art based on embodiments of the invention without creative efforts shall fall within the protection scope of the invention.

It should be understood that the directional or positional relations indicated by the terms “open”, “upper”, “lower”, “thickness”, “top”, “in”, “length”, “internal”, and “peripheral” are only used to facilitate and simplify the description of the invention, and rather than to indicate or imply that assemblies or elements referred to must have specific directions or must be formed and operated in specific directions. Therefore, these terms should not to be understood as a limitation to the invention.

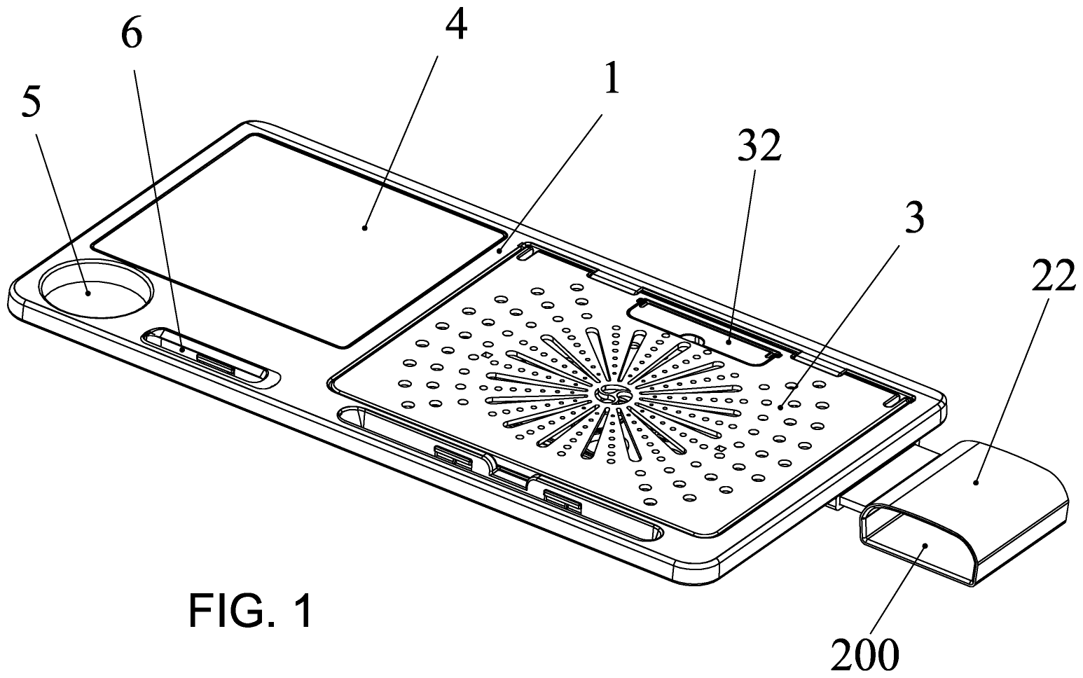

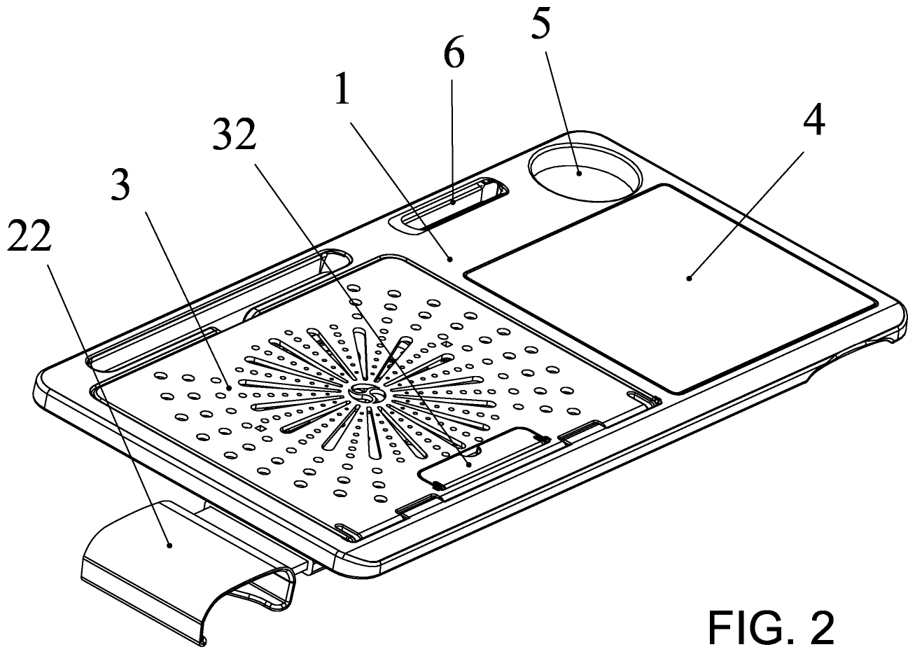

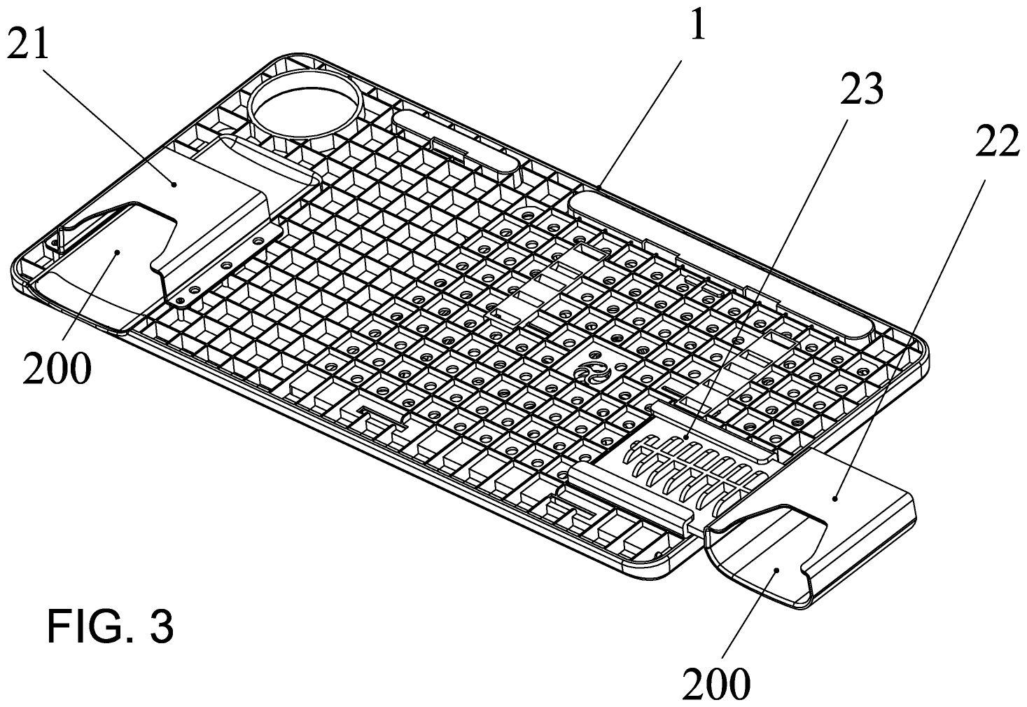

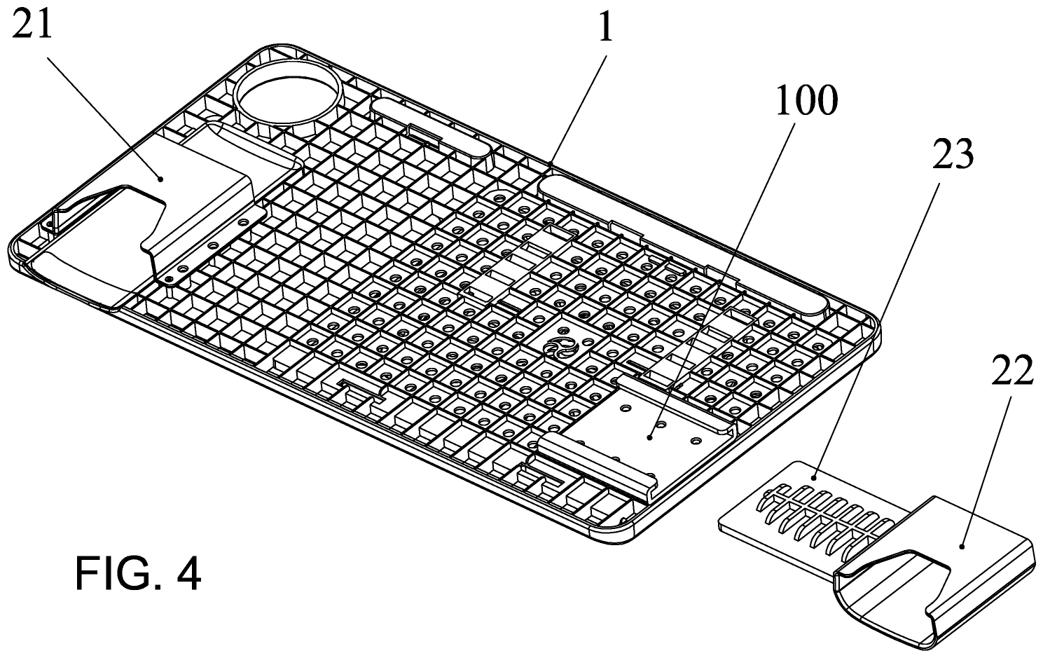

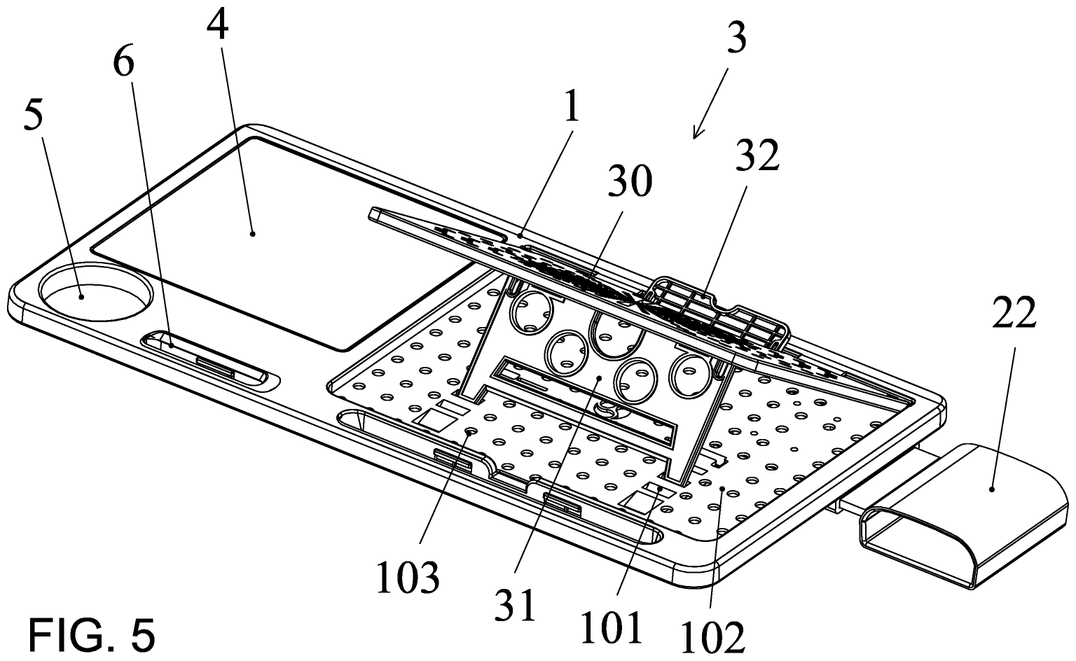

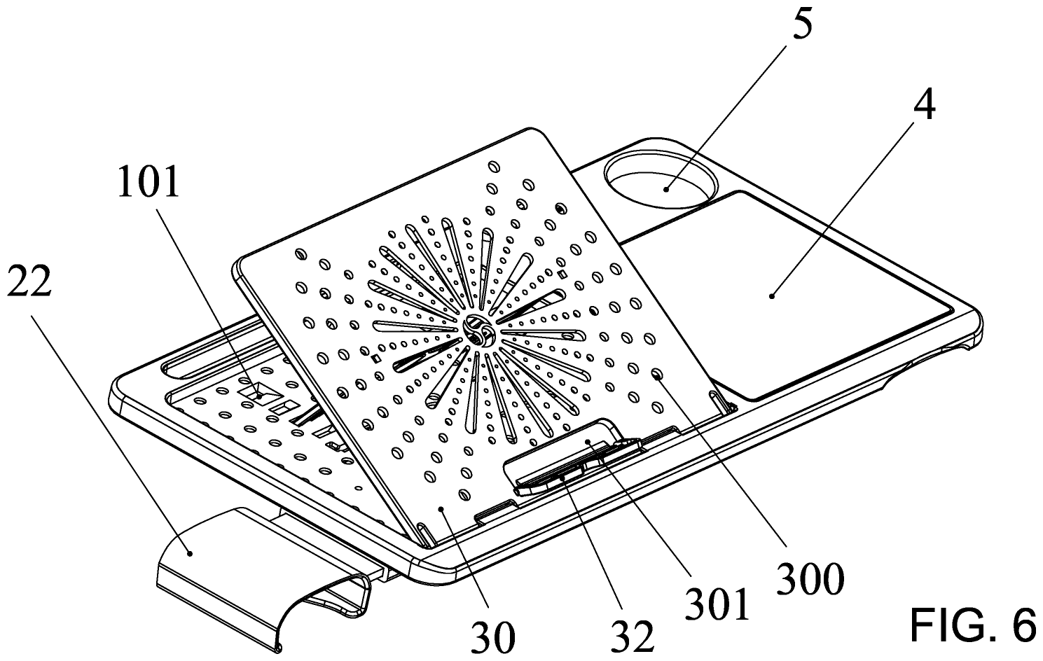

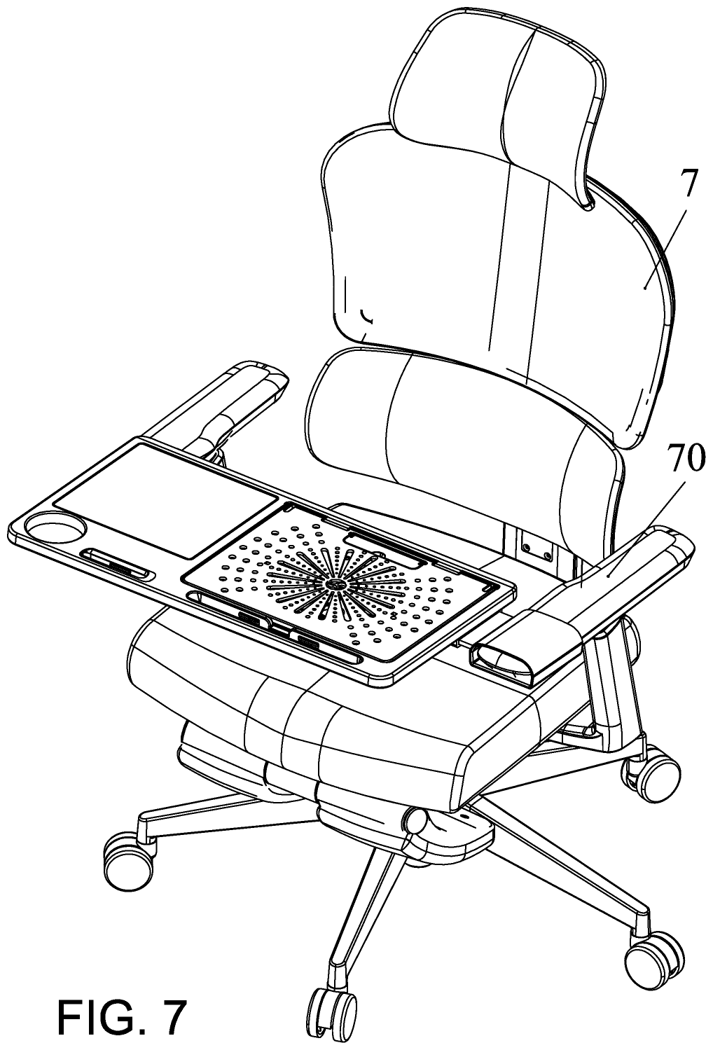

Referring to FIG. 1 to FIG. 7, a laptop computer holder comprises the following components as detailed below. A table 1 is provided for supporting a laptop computer. A first connector 21 and a second connector 22 are arranged at a lower end of the table 1. The first connector 21 is sleeved on one armrest 70 of a chair 7, and the second connector 22 is sleeved on the other armrest 70 of the chair 7.

The first connector 21 is fastened with a bottom end of the table 1.

A bottom of the table 1 is provided with a sliding groove 100 extending from one armrest 70 of the chair 7 to the other armrest 70 thereof. A sliding member 23 is arranged in the sliding groove, and the sliding member 23 is fastened with the second connector 22.

The first connector 21 and the second connector 22 each include a sleeve hole 200 that is formed by bending downward and wrapping, and the sleeve hole 200 is sleeved on the armrest 70 of the chair 7.

In the invention, the table 1 is used as a supporting body to support a computer placed on the table 1 or to support another object. In the drawings of the invention, the table 1 is in a rectangular shape. However, in an actual operation, the table 1 may be set as a round shape, square, triangle, or an irregular shape, that is, adjusted according to actual needs.

In the invention, the first connector 21 and the second connector 22 are used to detachably connect the table 1 with two armrests 70 of a chair 7. Generally, the laptop computer holder of the invention and the chair 7 are separately sold. An objective of invention is that the laptop computer holder may be installed on the chair 7, and in particular, may be installed on the armrest 70 of the chair 7. Because the installed laptop computer holder crosses at a front face of the chair 7, it requires that the laptop computer holder is detachably connected with the two armrests 70 of the chair 7, especially the laptop computer holder is convenient remove when in use. In the invention, the first connector 21 and the second connector 22 are directly sleeved on the two armrests 70 of the chair 7 through the sleeve hole 200, so that operations are convenient.

Due to the sliding groove 100, the first connector 21 and the second connector 22 move relative to each other, that is, the spacing between the first connecting member 21 and the second connecting member 22 is adjustable. Especially, for different chairs 7, a spacing between the armrests 70 of the chair 7 is different. Therefore, by adjusting a spacing between the first connector 21 and the second connector 22, the laptop computer holder of the invention can be applied to a chair 7 with a different spacing between armrests 70.

In the drawings of the invention, the sliding groove 100 presents linear distribution, and there may be one sliding groove 100. Certainly, in some cases, there may be a plurality of sliding grooves 100. Sliding blocks each that slide relative to each other are arranged in the plurality of sliding grooves 100, and the plurality of sliding blocks are connected with the second connector 22, to guide movement of the second connector 22.

Certainly, the sleeve hole 200 is sleeved on the armrest 70 of the chair 7 to realize quick disassembly. Because the sleeve hole 200 is sleeved on the armrest 70 of the chair 7, the sleeve hole 200 can move relative to the armrest 70 in this case. That is, in an actual application, a distance between the laptop computer holder and the human sitting on the chair 7 may be adjusted by using this feature based on an actual need, to improve comfort of a user.

In some cases, to ensure that the sleeve hole 200 is more stably sleeved on the armrest 70 of the chair 7, a rubber pad may be arranged on an inner side of the sleeve hole 200. When the sleeve hole 200 is sleeved on the armrest 70 of the chair 7, the rubber pad is in contact with a surface of the armrest 70, and the rubber pad is in a compressed state. In this case, stability of the sleeve hole 200 on the armrest 70 of the chair 7 is improved due to elasticity of the rubber pad and increased friction.

In the invention, when the human sits on the chair 7, the first connector 21 and the second connector 22 are respectively sleeved on the two armrests 70 of the chair 7, the laptop computer holder is stably installed on the chair 7, and the laptop computer is placed on the laptop computer holder.

The distance between the laptop computer holder and the human sitting on the chair 7 can be adjusted by moving the positions of the sleeve hole 200 and the armrest 70 of the chair 7, so that comfort of the user is improved.

For a chair 7 of which a height of an armrest 70 can be adjusted, because of this feature, a height of the laptop computer holder may be adjusted along with the armrest 70 itself. For example, when the user needs to adjust the height of the laptop computer holder, the user may adjust the height of the laptop computer holder by adjusting the height of the armrest 70, which is equivalent to reducing a height adjustment mechanism, that is, a structure of the holder is simplified.

In some embodiments, a laptop computer bracket 3 is arranged on the table 1. The laptop computer bracket 3 includes a supporting surface 30. The supporting surface 30 is close to a left hand side of a human according to a posture of the human sitting on the chair 7 as a reference.

The supporting surface 30 is rotationally installed at a position that is of the table 1 and that is close to the human sitting on the chair 7.

A rotary height adjustment plate 31 is arranged in a middle part of a back surface of the supporting surface 30, and the other end of the height adjustment plate 31 is inserted into a limiting hole 101 of the table 1.

When in use, one end of the height adjustment plate 31 is selectively inserted in the limiting hole 101 of the table 1. In this case, the height adjustment plate 31 supports the supporting surface 30, so that the supporting surface 30 is in an inclined state. In this case, the laptop computer is placed on the supporting surface 30, at this time, the laptop computer is in an inclined state close to the human, so that a user sitting on chair 7 may conveniently view the content in the laptop computer.

Certainly, in some cases, there are a plurality of limiting holes 101, and the plurality of limiting holes 101 are distributed in a longitudinal direction of the table 1. One end of the height adjustment plate 31 is inserted into different limiting holes 101 of the table top 1, to adaptively adjust an inclined angle of the supporting surface 30, that is, the inclined angle of the supporting surface 30 may be adjusted based on an actual need to meet the needs of the user.

Certainly, in some cases, a first heat dissipation hole 300 penetrating the supporting surface 30 is formed on the supporting surface 30, which is convenient to heat dissipation of the laptop computer on the supporting surface 30.

Certainly, in some cases, a supporting surface storage groove 102 is formed on the table 1, the supporting surface 30 is rotationally installed in the supporting surface storage groove 102, and the limiting hole 101 is formed in the storage groove 102. a second heat dissipation hole 103 penetrating the table 1 is formed in the supporting surface storage groove 102. When the supporting surface 30 is stored in the supporting surface storage groove 102, an upper end surface of the supporting surface 30 is flush with an upper end surface of the table 1, and the laptop computer is directly placed on the upper end of the whole of the supporting surface 30 and the table 1. Due to the second heat dissipation hole 103, when the supporting surface 30 is stored in the support surface storage groove 102, the second heat dissipation hole 103 is connected with the first heat dissipation hole 300, so that auxiliary heat dissipation at the bottom of the laptop computer may be realized when the laptop computer is directly placed on the upper end of the whole of the supporting surface 30 and the table 1.

Certainly, in some cases, a baffle storage groove 301 is arranged on a front supporting surface 30 close to the table 1. A baffle 32 is rotationally installed in the baffle storage groove 301. When the laptop computer is placed on the supporting surface 30, a free end of the baffle 32 extends out of the baffle storage groove 301 to support an edge of a lower end of the laptop computer. When the supporting surface 30 is in the inclined state, if the laptop computer is placed on the supporting surface 30 in this case, the laptop computer may slide downward. In the invention, the baffle 32 is unfolded, and a free end of the baffle 32 extends out of the baffle storage groove 301 to support the edge of the lower end of the laptop computer, to avoid the laptop computer from sliding downward. Certainly, in some cases, a sponge may be wrapped on the baffle 32 to reduce rigid contact between the laptop computer and the baffle 32, to protect the edge of the lower end of the laptop computer.

Suitable for the laptop computer, a mouse pad 4 is embedded in a surface of the table 1, and the mouse pad 4 is close to a right hand side of a human according to a posture of the human sitting on the chair 7 as a reference.

Certainly, in an actual application, other functions can be set according to use needs of an actual scenario. For example, a round hole 5 for placing a coffee cup is formed on the table 1, and the round hole 5 is close to a right hand side of a human according to a posture of the human sitting on the chair 7 as a reference. In this case, the coffee cup may be placed in the round hole 5. An elongated hole 6 for placing a mobile phone is formed on the table 1. In this case, the mobile phone may be placed in the elongated hole 6.

In the description of this specification, the description of the terms “one embodiment”, “an example”, “a specific example” or the like means that a specific feature, structure, material or characteristic described with reference to the embodiment(s) or example(s) is included in at least one embodiment or example of the invention. In this specification, the schematic representations of the foregoing terms do not necessarily refer to the same embodiment or example. Moreover, the described specific features, structures, materials or characteristics can be combined in any one or more embodiments or examples in a suitable manner.

While the invention has been described in terms of preferred embodiments, those skilled in the art will recognize that the invention can be practiced with modifications within the spirit and scope of the appended claims.

What is claimed is:

1. A laptop computer holder, comprising:
a table;
first and second connectors arranged at a lower end of the table wherein the first connector is sleeved on one armrest of a chair, the second connector is sleeved on the other armrest of the chair, and the first connector is fastened with a bottom end of the table;
a bottom of the table provided with a sliding groove extending from one armrest of the chair to the other armrest thereof; and
a sliding member arranged in the sliding groove and fastened with the second connector;
wherein the first and second connectors each include a sleeve hole that is formed by bending downward and wrapping, and the sleeve hole is sleeved on one armrest of the chair.

2. The laptop computer holder of claim 1, wherein a laptop computer bracket is arranged on the table, the laptop computer bracket comprises a supporting surface, and the supporting surface is close to a left hand side of a human according to a posture of the human sitting on the chair as a reference; the supporting surface is rotationally installed at a position that is of the table and that is close to the human sitting on the chair; and a rotary height adjustment plate is arranged in a middle part of a back surface of the supporting surface, and the other end of the height adjustment plate is inserted into a limiting hole of the table.

3. The holder of claim 2, wherein there are a plurality of limiting holes, and the plurality of limiting holes are distributed in a longitudinal direction of the table.

4. The laptop computer holder of claim 2, wherein a first heat dissipation hole penetrating the supporting surface is formed on the supporting surface.

5. The laptop computer holder of claim 4, wherein a supporting surface storage groove is formed on the table, the supporting surface is rotationally installed in the supporting surface storage groove, and the limiting hole is formed in the storage groove; and a second heat dissipation hole penetrating the table is formed in the supporting surface storage groove.

6. The laptop computer holder of claim 2, wherein a baffle storage groove is arranged on a front supporting surface close to the table; and a baffle is rotationally installed in the baffle storage groove, and when the laptop computer is placed on the supporting surface, and a free end of the baffle extends out of the baffle storage groove to support an edge of a lower end of the laptop computer.

7. The laptop computer holder of claim 1, wherein a mouse pad is embedded in a surface of the table, and the mouse pad is close to a right hand side of a human according to a posture of the human sitting on the chair as a reference.

8. The laptop computer holder of claim 1, wherein a round hole for placing a coffee cup is formed on the table, and the round hole is close to a right hand side of a human according to a posture of the human sitting on the chair as a reference.

9. The laptop computer holder of claim 1, wherein an elongated hole for placing a mobile phone is formed on the table.
